(19) United States
(12) Patent Application Publication
(10) Pub. No.: US 2004/0135018 A1
(43) Pub. Date: Jul. 15, 2004

(54) Swing away roller

(75) Inventor: Carl L. Bonner, Caldwell, ID (US)

Correspondence Address: DYKAS, SHAVER & NIPPER, LLP, P.O. BOX 877, 802 WEST BANNOCK STREET, SUITE 405, BOISE, ID, 83701, US

(73) Assignee: Diamond Z Manufacturing, Caldwell, ID (US)

(21) Appl. No.: 10/339,990

(22) Filed: Jan. 10, 2003

(51) Int. Cl. B02C 13/286

(52) U.S. Cl. 241/186.4

(57) ABSTRACT

An improved configuration of hammermill is provided in which the feed roller assembly of a horizontal hammermill has an improved safety feature. The feed roller assembly is lifted up to an open position so that the hammermill can be accessed for maintenance. In the open position, the center of gravity of the feed roller assembly is past a pivot point so that the feed roller assembly will fall away from and not toward the hammermill even if hydraulics or safety latches fail.

### BACKGROUND OF THE INVENTION

1. Field of the Invention

The present invention generally relates to hammermills, and more particularly relates to horizontal feed hammermills in which a feed roller swings away for maintenance of the hammermill.

2. Background Information

Hammermills, in general, and horizontal fed hammermills, in particular, may utilize a feed roller that presses down on material being fed into the hammermill and assists in feeding it into a hammermill. In a horizontal hammermill, the feed material is typically fed into the hammermill by some sort of conveyor belt or conveyor chain. In such a horizontal hammermill, a roller may ride on the feed material or be pressed down against the feed material, pressing it against the conveyor belt. The feed roller may either passively or actively rotate and push the feed material into the hammers of the hammermill.

In such a hammermill, the hammers are typically very heavy, and require frequent maintenance. The hammers for some hammermills weigh 120 pounds each, and are bolted to the generally cylindrical body of the hammermill. Typically, these hammers have hammer tips that may be replaced daily on the hammers. The hammer tips or other wear parts are typically bolted or pinned to the hammermill. A screen is located below the hammermill. This screen is made of thick steel and may have various sized holes. In such a horizontally fed hammermill, the feed roller must be moved away from the hammermill so that the hammer tips, screens, and hammers can be maintained or replaced. Typically, a pair of hydraulic cylinders lift the feed roller up and away from the hammermill, providing access for maintenance for the wear parts of the hammermill.

The problem with such an arrangement is that the feed roller has an inherent tendency to fall back down into place adjacent the hammermill. Hammermills of this design may typically have a safety lock, or some other device that would prevent the feed roller from coming down into its working position. However, on a worksite, it is often a problem that the worker may not engage the safety devices, or they may have become damaged over time and may no longer operate. Such safety devices can also fail. For all of these reasons, a problem with horizontally fed hammermills is that the feed roller has a tendency to come down into its working position and can injure or crush a worker who is in a position to maintain the hammermill.

Therefore, one object of the present invention is to present a hammermill design that is inherently safe, and does not require the activation of a locking mechanism or a safety catch. Such a device, to be useful, would also not require any extra action by the worker, and would not operate unless it were in a safe position.

Another problem presented by typical hammermill designs is that the screens are difficult to access and remove, and they must be removed or replaced periodically. A hammermill screen may be a piece of curved steel that is one-half to one inch thick, and have various sized holes. If a different size of end product were desired, the screen would have to be removed and replaced with a more suitable screen. It is not unusual for removal of a screen to take four and a half hours.

Sometimes, such screens are in four segments. Thus, another object of the present invention is to present a design that facilitates changing of screens, increases speed, ease, and safety, and which also interacts with the design in a way that increases the safety of the maintenance worker when the feed roller is raised away from the hammermill.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects are achieved by a grinding machine of the present invention. The grinding machine of the present invention is a grinding machine for comminuting materials into smaller pieces. It is mounted on a grinding machine frame which may be stationary, or which may be transported from place to place. It includes a generally cylindrical hammermill to which are attached removable hammers that strike the feed material and break it into smaller pieces. The hammermill is partially surrounded by a sturdy screen with openings in the screen to allow particles of a certain size to pass through. The hammermill has a central axis around which it rotates. It is mounted to the grinding machine frame so that the hammermill central axis is in a generally horizontal position.

One side of the hammermill is designated as the maintenance side, while the other side is designated as a closed side. The maintenance side is the side of the hammermill from which the hammers can be made accessible for maintenance.

The grinding machine includes a feed roller assembly. The feed roller assembly is made up of a feed roller, which presses down on feed material and assists in moving feed material toward the hammermill, and a hood that covers the feed roller. The feed roller is able to move up and down while still pressing on the feed material in order to accommodate feed material of varying thickness. The feed material is generally conveyed into the hammermill on a conveyor belt, or its equivalent.

A hood covers the feed roller and the hammermill. The hood helps prevent material from flying away from the grinding machine as it is being struck by the hammers of the hammermill. The hood may be positioned in a closed position when the hammermill is in operations, and in this position generally covers the hammermill and the area around the hammermill. The hood and feed roller assembly may also be moved to an open position, in which the feed roller and the hood are lifted up and away from the hammermill, so that the hammermill itself is accessible for maintenance.

The feed roller assembly pivots from the closed to the open position around one or more roller assembly pivots. These are attached to the grinding machine frame and allow the feed roller assembly to rotate away from the hammermill. The attachment to the frame may be via mill walls or another connecting structure. The invention also includes a lifting mechanism that is configured to lift the feed roller assembly from a closed position to the open position, and back into the closed position when maintenance is complete.

The feed roller assembly has a center of gravity, and the device is configured so that when the feed roller assembly has been lifted into the open position by the lifting mechanism, the center of gravity of the feed roller assembly is on the side of the assembly pivots away from the hammermill. This results in the feed roller assembly tending to fall away from the closed position rather than towards the hammermill and the open position. Thus, if the safety devices or lifting mechanism failed, the feed roller assembly would not fall towards the worker or the hammermill. The purpose for this is to add to the safety of the hammermill. What can happen during operation of such a device is that the feed roller assembly can fall towards the hammermill and a worker who is replacing hammers or hammer tips on the hammermill may be injured or killed in such a fall. By the configuration of the device of the invention, such a failure is prevented.

Although the device of the invention can be applied to a number of different configurations of grinding machines, it is particularly adaptable to a grinding machine in which the hammermill is in a generally horizontal plane and in which the material fed into the hammermill is conveyed into the hammermill in a generally horizontal plane. This can be by a conveyor like device, such as a feed chain or conveyor belt. The device would typically include two roller pivots, with the first pivot located on the left side of the grinding machine, and a second pivot connected to the right side of the grinding. The first and second pivots may not be connected directly to the frame, but they will be mounted to some component such as mill walls, which are connected to the frame. The pivots may be connected at another end to the frame at one end and to the feed roller assembly and hood at the other end. When activated, the cylinders lift the feed roller assembly and the hood into the open position.

One type of lifting mechanism for the device is a hydraulic system, which would include at least one hydraulic cylinder, a hydraulic pump, and hydraulic oil. The system would typically operate by two hydraulic cylinders.

The feed material enters the hammermill from the maintenance side of the hammermill, is comminuted by the hammers, and exits through the screen, which is configured to be at least partially below the centerline of the hammermill. In such a hammermill, the material to be comminuted would be discharged from the closed side or the bottom of the hammermill through the screen of the hammermill. Part of the screen may be above the centerline of the hammermill. In the typical configuration of the invention, the pivot points would be located on the closed side of the hammermill, but this position of the pivots is not mandatory.

The grinding machine of the present invention typically includes a lid assembly for covering the upper side of the hammermill. The lid assembly would typically be a generally rectangular structure with one side open, which would nest inside the hood of the feed roller assembly. The lid would typically be rotationally joined to the roller assembly pivots. The feed roller assembly would be free to rotate independently of the lid assembly. In one embodiment of the invention, the lid would also be configured for locking to the frame of the grinding machine, or to some component that is connected to the frame, such as the mill walls.

The lid can also be configured to be disconnected from the frame and to be connected to the feed roller assembly so that the two can move in unison. In one version of the invention, the lid assembly is configured to interact with the hammermill screen that surrounds part of the hammermill. Thus, when the lid assembly is in the locked position to the grinding machine frame, the hammermill screen is locked in position by the locking edge of the lid. When the lid assembly is released from the locked position and raised away from the hammermill, the hammermill screen is unlocked and may be removed for replacement or maintenance. In this version of the device, the lifting mechanism would be configured to lift both the lid assembly and the roller feed assembly when the two are locked together, lifting them both into the open position.

The grinding machine of the invention could include a pins locking system. The locking system contains a first pins assembly, which releasably locks the lid to the feed roller assembly. A second pins assembly releasably locks the lid to the grinding machine frame. When one pins is engaged, the other one is disengaged. Thus, when the machine is in a typical operating mode, the second pins assembly would lock the lid to the grinding machine frame, and the lid would remain over the hammermill in a fixed relationship. When the machine was going to be serviced, the second pins assembly would unlock from the frame, and the first pins assembly would lock the lid to the feed roller assembly. Then, the lifting mechanism would lift both the feed roller assembly and the lid from the closed to the open position. In a typical operating mode, the feed roller assembly is free to move up and down according to the depth of the feed material. It can also be pressed against the feed material to aid in compressing the material and moving it towards the hammermill. In a typical operation, the lid assembly is locked in a stationary position through the mill walls to the grinding machine frame.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a side view of the hammermill of the present invention in a working position.

FIG. 2 is a side view of the hammermill of the present invention in a working position in which the feed roller has been raised by material being fed into the hammermill.

FIG. 3 is a side view of the hammermill of the invention in which the feed roller assembly and the lid have been raised to an open position by a lifting mechanism.

FIG. 4 is an end view of the hammermill of the invention showing the first pins connecting the lid assembly to the feed roller assembly.

FIG. 5 is an end view showing the second pins attaching the lid assembly to the mill walls.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

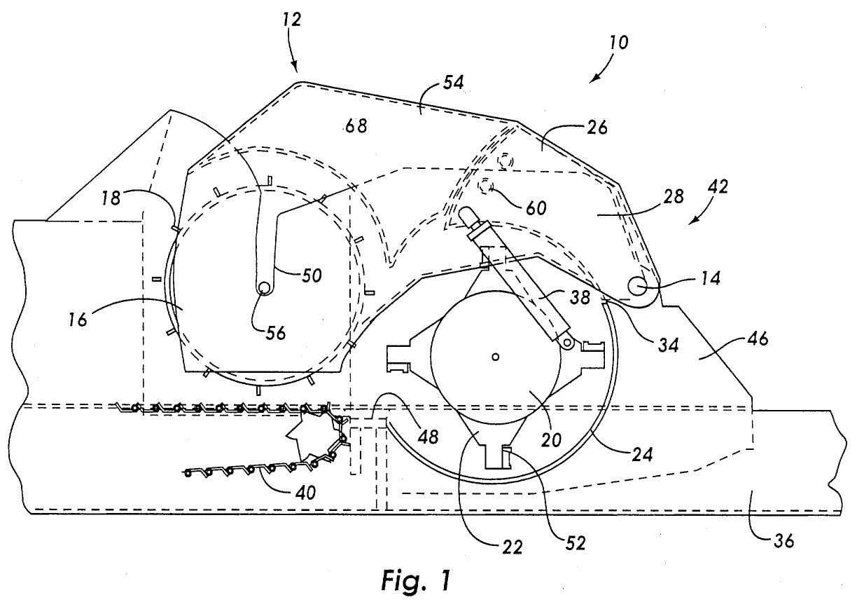

By means of illustration, a preferred embodiment of the grinding machine of the invention is shown in FIGS. 1-5.

FIG. 1 is a side view of a grinding machine of the invention in the working or closed position 42. It includes a hammermill 20 with attached hammers 22 and hammer tips 52. The hammer is mounted to a grinding machine frame 36. Material is fed to the hammermill by a feed chain 40. A feed roller 16, which optionally may include feed roller lugs 18, assists in feeding material to the hammermill. The feed roller 16 presses down on feed material and assists in pushing it towards the hammermill. The rotating hammers 22 of the hammermill swing past a cutter bar 48, which operates with the hammer tips 52, to cut pieces of feed material into smaller pieces. The hammermill is partially surrounded by a screen 24, which has openings through which comminuted material passes.

The hammermill can be sized according to the requirements of the job that it is expected to be performed. A typical hammermill configured as discussed above, might be from 36 to 72 inches wide and approximately 48 inches in diameter. One preferred size for such a hammermill would be a hammermill that is 66 inches wide and 52 inches in diameter. The hammers of such a hammermill could easily weigh 120 pounds each, and would be bolted to the hammermill with long bolts, which normally extend the length of the hammermill.

The feed roller 16 is part of a feed roller assembly, which is generally referred to as 12 in the drawings. The feed roller assembly includes the feed roller 16, the hood 54, feed roller arms 68 and the pivot pin 14. In operation, the feed roller assembly is mounted above the hammermill, and moves up and down as the feed roller rides on top of feed material being fed into the hammermill. The feed roller 16 is enclosed on either side by a pair of mill walls 46, and feed roller arms 68 are outside the mill walls. These parts are typically made of steel and some typical dimensions are a feed roller 50 inches in diameter, a hood made of three-quarter inch steel, and a pivot pin, which is an axle that is three inches in diameter and 66 inches long, depending on the size of the hammermill. The mill walls 46 are typically three-quarter inches thick and rigidly attached to the frame 36.

The feed roller has an axle 56, which fits inside the axle slots 50 in the mill walls 46. There is an axle slot 50 in each mill wall 46 through which the axle of the feed roller 16 passes. The axle slot 50 allows the feed roller 16 to move up and down in relation to the mill walls 46, which are attached to the grinding machine frame 36.

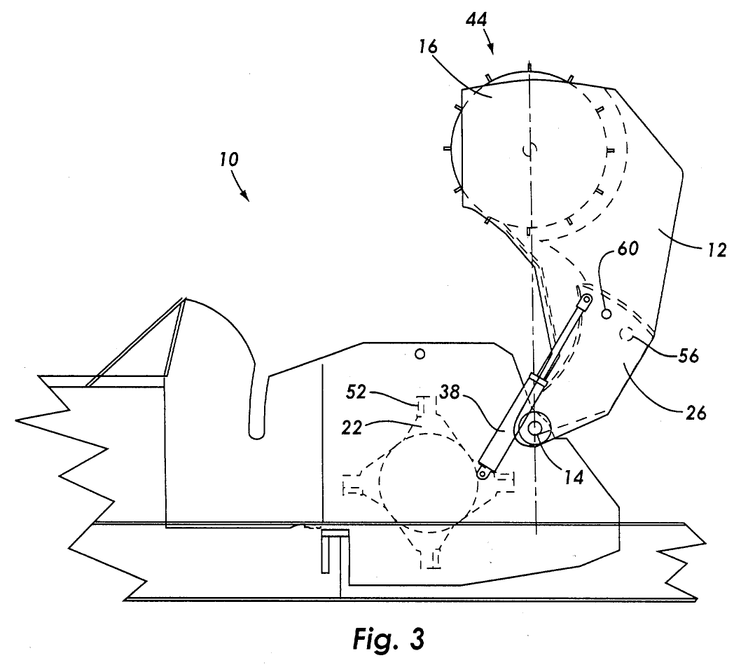

A lifting mechanism is provided which can lift the entire feed roller assembly away from the hammermill. In FIG. 1, the lifting mechanism is shown as a lifting cylinder 38, which is attached at one end to the mill walls 46 and attached at the other end to the hood 54. Typically, two lifting cylinders are utilized, one on each side. The grinding machine 10 shown in FIG. 1 is configured so that the feed roller assembly is in a working, or closed position 42 with the feed roller contacting material on the feed chain 40 being fed into the hammermill. The lifting cylinders 38 can also lift the feed roller assembly 12 up and away from the hammermill into an open position 44, which is seen in FIG. 3. The lifting cylinder 38 would be sized according to the requirements of the feed roller assembly to which it was attached, and might typically be five inches in diameter with a throw of 30 inches.

Nested inside the hood 54 is a lid assembly 26. The lid assembly 26 includes a lid 28, which is closed on the side toward the hammermill and closed on the other sides, and a locking edge 34. The lid 28 pivots around the pivot pin 14, and during operation locks into place to the mill walls 46. The lid assembly 26 may also be unlocked from the mill walls, and may be locked to the feed roller assembly 12. This would occur when maintenance was to be performed on the hammermill. With the lid assembly 26 locked to the feed roller assembly 12, the lifting cylinder 38 can then lift the two together into the open position 44, which allows easier access to the hammermill 20. The lid 28 includes a locking edge 34, which contacts and holds the screen 24 in place. When the lid 28 is lifted away from the hammermill, this unlocks the screen 24 and allows the screen 24 to be easily removed from the hammermill.

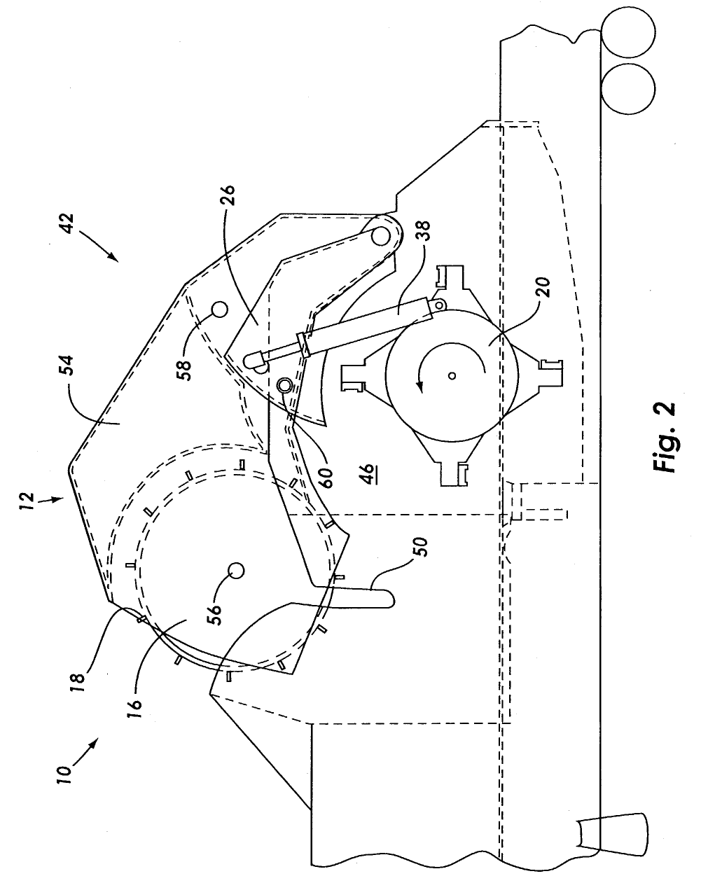

FIG. 2 shows how the hammermill can appear during operation. In this configuration, the lid assembly 26 is locked to the mill walls 46 and remains stationary during operation. The feed roller assembly 12 can move up and down, and in this view is higher than the view shown in FIG. 1. For this to happen, the feed roller axle 56 has to rise out of the axle slots 50 in the mill walls. This can happen when bulky material is on the feed chain 40. Optionally, the lifting cylinder 38 can be used to apply downward pressure on the feed roller assembly to more forcefully press down on feed material being fed into the hammermill 20.

The hammermill is shown in FIG. 3 in the open position 44. In this position, the lifting cylinder 38 is fully extended and the feed roller assembly 12, with the attached lid assembly 26, is raised above the grinding machine 10. In this position, the hammer tips 52 and the hammers 22 may be easily accessed for maintenance. Also, the screen 24 may be easily removed in the open position.

The combined structure of the feed roller assembly 12 and the lid assembly 26 has a center of gravity. The grinding machine 10 is configured so that in the open position 44, the center of gravity of the combined feed roller assembly 12 and the lid assembly 26 is positioned to fall away from the hammermill. This means that if the lifting cylinder 38, the hydraulic line, the hydraulic cylinder, or safety lock fails, the feed roller assembly and lid assembly will tend to fall away from the closed position adjacent the hammermill rather than towards it. This is a safety feature, and an important feature of the grinding machine of the invention. Because of this feature, a worker can be on the feed side of the hammermill, and not be in danger of the heavy weight of the feed roller assembly 12 falling down on him/her.

In this particular embodiment, the pivot pin 14 is located on the output side of the hammermill, rather than the input side. Other configurations of the device could have the pivot pin in different positions such as in the same vertical plane as the hammermill, or even on the input side of the hammermill. The important feature is that the center of gravity of the feed roller assembly 12 comes to rest in the open position so that if any part of the lifting mechanism 38 fails, the feed roller assembly 12 will not fall toward its closed position adjacent the hammermill.

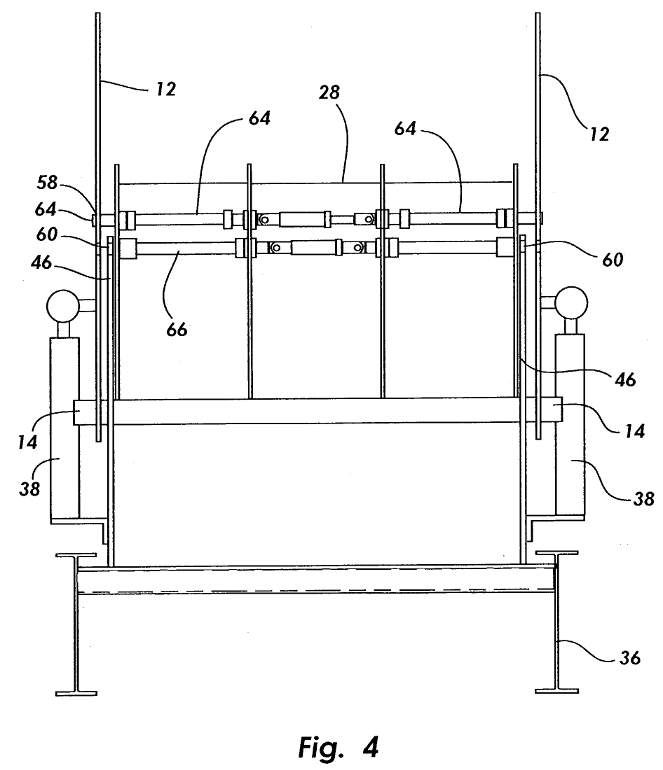

FIG. 4 shows a pair of first pins 64 and a pair of second pins 66, and how they serve to link the lid 28 to either the feed roller assembly 12 or to the frame 36 through the mill walls 46. In FIG. 4, the pair of first pins 64 is extended, and thus connects the lid assembly 28 to the feed roller assembly 12 through the first pinhole 58. Although these devices can be of various sizes, a successful size for the first pins 64 is two inches in diameter and made of steel. As shown in FIG. 4, when the pair of first pins 64 connects the lid assembly 28 with the feed roller assembly 12, the pair of second pins 66 is retracted as shown in FIG. 4. In the linkage shown in FIG. 4, the lifting cylinder 38 could be extended and used to lift both the feed roller assembly 12 and the lid assembly 28 into the open position.

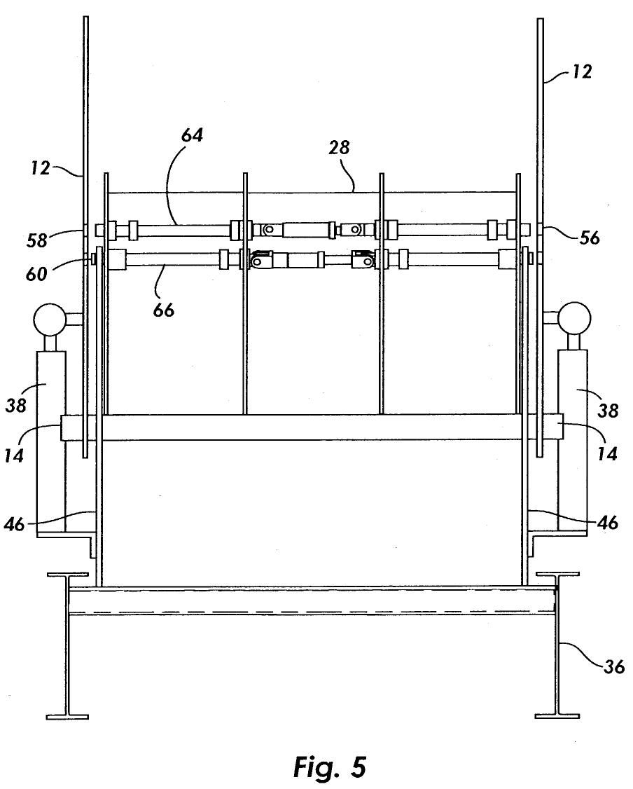

FIG. 5 shows the opposite configuration to the one shown in FIG. 4, in which the pair of first pins 64 are retracted, and the pair of second pins 66 are extended into the second pinholes 60. In this configuration, the lid assembly 28 is locked rigidly to the frame 36 through the mill walls 46. The feed roller assembly 12 is free to rotate up and down with material being fed into the hammermill around the pivot pin 14.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A grinding machine which comprises:
a grinding machine frame;
a generally cylindrical hammermill with an axis, which is attached to said grinding machine frame so that said hammermill axis is horizontal, for comminuting material, which includes a maintenance side on a horizontal plane to one side of said axis, from which side said hammermill receives maintenance, and a closed side opposite said maintenance side from which said hammermill is not accessed for maintenance of said hammermill;
a feed roller assembly which comprises a feed roller which presses down on feed material and assists in moving said feed material toward said hammermill, and a hood for covering said hammermill, which is configured for positioning in a closed position when said hammermill is in operation, and in an open position for maintenance of said hammermill, in which said roller assembly has a center of gravity;
a lifting mechanism for lifting said feed roller assembly from said closed position to said open position, and from said open position to said closed position; and
one or more roller assembly pivots, through which said roller assembly is attached to said grinding machine frame, and around which said roller assembly rotates in a first plane when moving between said closed and said open position, and in which a vertical plane can be formed through a centerline of said one or more roller assembly pivots transverse to said first plane, with said vertical plane defining a raised side and a lowered side of said one or more roller assembly pivots;
wherein said feed roller assembly is configured so that when in said open position, said center of gravity of said roller assembly is located on said raised side of said roller assembly pivots, so that a failure of said lifting mechanism will not result in said feed roller assembly falling towards said maintenance side of said hammermill or towards closed position.

2. The grinding machine of claim 1 which is configured so that material fed into said hammermill is conveyed into said hammermill in a generally horizontal plane, and said hammermill is oriented in a generally horizontal plane.

3. The grinding machine of claim 1 which further includes two roller assembly pivots, with a first pivot connected to a left side of said grinding machine frame, and a second pivot connected to a right side of said grinding machine frame.

4. The grinding machine of claim 1 in which lift moving mechanism is hydraulic system including at least one hydraulic cylinder and a hydraulic pump and hydraulic oil.

5. The grinding machine of claim 1 in which said feed material enters said hammermill from said maintenance side of said hammermill.

6. The grinding machine of claim 5 in which said feed material discharges said hammermill from said closed side or a bottom of said hammermill.

7. The grinding machine of claim 1 in which said one or more pivot points are on closed side of hammermill.

8. The grinding machine of claim 1 which further includes a lid assembly for covering said hammermill and for attachment to said feed roller assembly, with said lid assembly nesting inside said feed roller assembly.

9. The grinding machine of claim 8 in which said lid assembly is rotationally joined to said one or more roller assembly pivots, and said lid assembly rotates around said one or more roller assembly pivots independently of said feed roller assembly.

10. The grinding machine of claim 9 in which said lid assembly can be releasably locked to said feed roller assembly, so that said lid assembly and said feed roller assembly move together when locked together.

11. The grinding machine of claim 10 in which said lid assembly can be releasably locked to said grinding machine frame, so that said lid assembly remains in a fixed and stationary position around said hammermill when said hammermill is in operation.

12. The grinding machine of claim 11 in which said lid assembly interacts with a hammermill screen which surrounds part of said hammermill, so that when said lid assembly is in a locked position to said grinding machine frame, said hammermill screen is locked in position by said lid assembly, and when said lid assembly is released from said locked position to said grinding machine frame, said hammermill screen is unlocked and may be removed.

13. The grinding machine of claim 12 in which said lifting assembly is configured to lift said lid assembly and said feed roller assembly when said lid assembly and said feed roller assembly are locked together.

14. The grinding machine of claim 8 in which said lid assembly is a closed structure open on one side, which is mounted to ride over said hammermill.

15. The grinding machine of claim 12 which includes a pins locking system comprising a first pins assembly which releasably locks said lid to said feed roller assembly, and a second pins assembly which releasably lock said lid to said grinding machine frame.

16. The grinding machine of claim 15 in which said lid locks to said grinding machine frame via a pair of mill walls which are connected to said grinding machine frame.

17. The grinding machine of claim 16 which is configured so that when in operation, said feed roller assembly moves up and down with depth of feed material, and said lid assembly is locked in a stationary position to said mill walls and through said mill walls to said grinding machine frame.
